(19) United States
(12) Patent Application Publication
(10) Pub. No.: US 2008/0133059 A1
(43) Pub. Date: Jun. 5, 2008

(54) Table-driven test sequence

(75) Inventors: Christine G. Trippel, Mishawaka, IN (US); Joseph E. Perry, Osceola, IN (US)

Correspondence Address: NIXON PEABODY LLP, 161 N. CLARK STREET, 48TH FLOOR, CHICAGO, IL, 60601, US

(73) Assignee: Bayer HealthCare LLC

(21) Appl. No.: 11/986,824

(22) Filed: Nov. 27, 2007

Related U.S. Application Data
(60) Provisional application No. 60/873,038, filed on Dec. 5, 2006.

(51) Int. Cl. G05B 15/00

(52) U.S. Cl. 700/267; 700/266

(57) ABSTRACT

A method for controlling a test sequence for performing an analysis of an analyte in a fluid sample includes providing a hard-coded software application adapted to process a plurality of blocks to perform the test sequence. The blocks include a wait block, a read block, and a threshold block. A test-sequence table having a plurality of attributes defined therein for each of the blocks is provided. The attributes are utilized by the software application to process the blocks. The test sequence is determined through the attributes defined within the test-sequence table.

### CROSS REFERENCE TO RELATED APPLICATION

This application claims priority to Application No. 60/873,038 filed on Dec. 5, 2006, which is incorporated by reference in its entirety.

### FIELD OF THE INVENTION

The present invention relates generally to diagnostic instruments and, more particularly, to a system and method for performing a test sequence utilizing a table-driven software application.

### BACKGROUND OF THE INVENTION

The quantitative determination of analytes in body fluids is of great importance in the diagnoses and maintenance of certain physiological abnormalities. For example, lactate, cholesterol and bilirubin should be monitored in certain individuals. In particular, determining glucose in body fluids is important to diabetic individuals who must frequently check their blood glucose levels to regulate the glucose intake in their diets.

The determination of the analyte concentration in a fluid sample may be performed in disposable self-testing systems. The disposable self-testing systems are often used by end consumers, especially those who are diabetic. Alternatively, the determination of the analyte concentration in a fluid sample may be performed in clinical analyzers. Clinical analyzers are often used in hospitals or clinics. Both the disposable self-testing systems and the clinical analyzers perform an electrochemical analysis on the fluid sample, for instance, by utilizing an electrochemical test sensor.

Where an electrochemical test sensor is used, a test sequence is performed by the self-testing system or the clinical analyzer. The test sequence may include a plurality of time intervals, current measurement frequency, applied current intensity, voltage, etc. required for the particular test sensor being used. The test sequence is typically performed by a microprocessor that is driven by software located on a testing device. The software provides the instructions for the microprocessor to perform, which causes the testing device to perform the electrochemical analysis. Typically, the instructions for the test sequence are hard-coded within the software and, as such, the configurability of the software is limited. Thus, when an upgrade is made to the electrochemical sensor or chemistry thereon, the test procedure, and/or the testing device a new software application is required to be loaded on the testing device.

It would be desirable to have a testing device and method for conducting a test sequence that can be easily upgraded without modifying the existing source code on the memory device.

### SUMMARY OF THE INVENTION

According to one embodiment of the present invention, a method for controlling a test sequence for performing an analysis of an analyte in a fluid sample is disclosed. The method comprises the act of providing a hard-coded software application adapted to process a plurality of blocks to perform the test sequence. The plurality of blocks includes a wait block, a read block, and a threshold block. The method further comprises the act of providing a test-sequence table having a plurality of attributes defined therein for each of the plurality of blocks. The plurality of attributes is utilized by the software application to process the plurality of blocks. The test sequence is determined through the plurality of attributes defined within the test-sequence table.

According to another embodiment of the present invention, the above-disclosed method further comprises the act of modifying the test-sequence table without recoding the hard-coded software application. The test-sequence table may be modified by, for example, changing the existing test-sequence table or providing an additional test-sequence table accessible by the hard-coded software application.

According to yet another embodiment of the present invention, a testing device adapted to utilize a test sensor in performing an analysis of an analyte in a fluid sample is disclosed. The testing device comprises an electronics assembly, a memory device, and a processor. The electronics assembly is adapted to provide a voltage to the test sensor and to determine an amount of current being transmitted by the test sensor. The memory device is capable of storing a test-sequence table thereon. The test-sequence table has a plurality of attributes defined therein. The processor is in communication with the electronics assembly and the memory device. The processor being operable to (i) perform a plurality of instructions contained within a software application, (ii) access the plurality of attributes defined within the test-sequence table to perform a test sequence, (iii) instruct the electronics assembly to provide the voltage to the test sensor, the voltage being defined by one of the plurality of attributes defined in the test-sequence table, and (iv) instruct the electronics assembly to determine the amount of current being transmitted by the test sensor, the frequency of the determinations being based on one of the plurality of attributes.

According to still another embodiment of the present invention, a method for conducting a test sequence is disclosed. A hard-coded software application is adapted to process a plurality of blocks to perform the test sequence. For each of the plurality of blocks, a plurality of attributes defined within a test-sequence table is read. The plurality of attributes is utilized by the software application to process the plurality of blocks. The test sequence is controlled based on the plurality of attributes defined within the test-sequence table.

According to a further embodiment of the present invention, a method for conducting a test sequence is disclosed. A hard-coded software application is adapted to process a plurality of blocks to perform the test sequence. For each of the plurality of blocks, a plurality of attributes defined within a test-sequence table is read. The plurality of attributes is utilized by the software application to process the plurality of blocks. A test sensor is sampled at a plurality of times based on the plurality of attributes defined within the test-sequence table.

The above summary of the present invention is not intended to represent each embodiment, or every aspect, of the present invention. Additional features and benefits of the present invention are apparent from the detailed description and figures set forth below.

### BRIEF DESCRIPTION OF THE DRAWINGS

FIG. 1 is an exploded view of an electrochemical sensor according to one embodiment that may be used in a method of the present invention.

FIG. 2 is a sensor base and those elements that are applied directly to the base of the sensor in FIG. 1.

FIG. 3 is an exploded view of a testing device, according to one embodiment of the present invention.

FIG. 4 is an exploded view of the electronics assembly and connection mechanism of the testing device of FIG. 3.

FIG. 5 is a perspective view of the electronics assembly of FIGS. 3-4.

FIG. 6 is a perspective view of the testing device of FIG. 3 with the test sensor of FIGS. 1-2 inserted therein, according to one embodiment.

FIG. 7 is flowchart depicting a sequence of steps to determine the concentration of an analyte in a fluid test sample according to one method of the present invention.

FIG. 8 is a flowchart depicting a method of performing a test sequence utilizing the testing device of FIGS. 3-6, according to one embodiment of the present invention.

FIG. 8a is a flowchart further depicting the test-in-progress step of FIG. 8, according to one embodiment of the present invention.

FIG. 8b is a flowchart further depicting the threshold step of FIG. 8a, according to one embodiment of the present invention.

FIG. 8c is a flowchart further depicting the read step of FIG. 8a, according to one embodiment of the present invention.

FIG. 8d is a flowchart further depicting the wait step of FIG. 8a, according to one embodiment of the present invention.

While the invention is susceptible to various modifications and alternative forms, specific embodiments are shown by way of example in the drawings and are described in detail herein. It should be understood, however, that the invention is not intended to be limited to the particular forms disclosed. Rather, the invention is to cover all modifications, equivalents and alternatives falling within the spirit and scope of the invention.

### DESCRIPTION OF ILLUSTRATED EMBODIMENTS

The present invention is directed to a system and method for performing a test sequence utilizing a table-driven software application. The test sequence may be used in conjunction with an electrochemical testing device to assist in determining the concentration of an analyte in a fluid sample.

Lancing devices and lancets may be used to produce a blood or body fluid sample from a test subject. This sample may then be analyzed with an electrochemical testing device and test sensor, or similar devices, to determine the concentration of the analyte to be examined. Examples of the types of analytes that may be collected with a lancing device include glucose, lipid profiles (e.g., cholesterol, triglycerides, LDL and HDL), microalbumin, hemoglobin Aic, fructose, lactate, or bilirubin.

To determine the analyte concentration in a fluid sample, an electrochemical sensor can be used. It is important that the electrochemical sensor provides reliable and reproducible measurements. According to one embodiment, the electrochemical sensor in the present invention may be that described in U.S. Pat. Nos. 6,531,040 and 6,841,052 entitled Electrochemical-Sensor Design and issued on Mar. 11, 2003, and Jan. 11, 2005, respectively, which are incorporated by reference in their entirety.

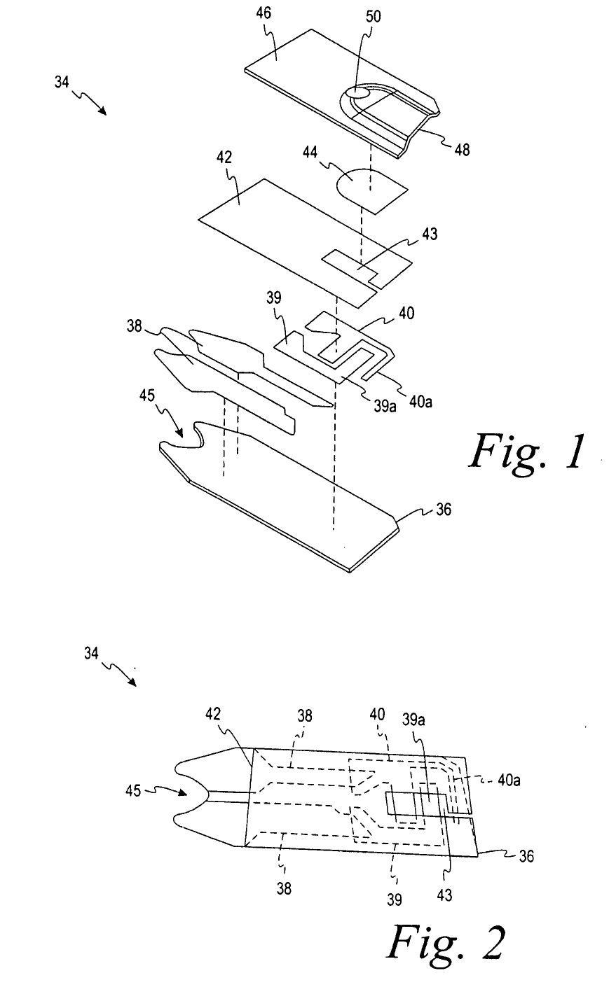

An example of an electrochemical sensor described in U.S. Pat. Nos. 6,531,040 and 6,841,052 is depicted in FIG. 1. Referring to FIG. 1, a sensor 34 comprises an insulating base 36 upon which is printed in sequence (typically by screen printing techniques), an electrical conductor pattern 38, an electrode pattern (portions 39 and 40), an insulating (dielectric) pattern 42, and a reaction layer 44. The base of the electrochemical sensor provides a flow path for the fluid test sample. The sensor 34 is shown in FIG. 2 in which all of the elements on the base 36 are shown in the same plane.

The function of the reaction layer 44 is to convert glucose, or another analyte in the fluid test sample, stoichiometrically into a chemical species which is electrochemically measurable, in terms of electrical current it produces, by the components of the electrode pattern. The reaction layer 44 generally contains a biosensing or reagent material, such as an enzyme, and an electron acceptor. More specifically, the reaction layer 44 contains an enzyme that reacts with the analyte to produce mobile electrons on the electrode pattern and an electron acceptor (e.g., a ferricyanide salt) to carry the mobile electrons to the surface of the working electrode. The electron acceptor may be referred to as a mediator in which the mediator is reduced in response to a reaction between the analyte and the enzyme. The enzyme in the reaction layer may be combined with a hydrophilic polymer, such as polyethylene oxide. An enzyme that may be used to react with glucose is glucose oxidase. It is contemplated that other enzymes may be used such as glucose dehydrogenase.

The two portions 39, 40 of the electrode pattern provide the respective working and counter electrodes necessary to electrochemically determine the analyte. The working electrode 39a typically comprises an enzyme that reacts with the analyte. The working and counter electrodes may be configured such that the major portion of the counter electrode 40a is located downstream (in terms of the direction of fluid flow along the flow path) from the exposed portion of a working electrode 39a. This configuration allows the test fluid sample to completely cover the exposed portion of the working electrode 39a.

The counter electrode sub-element 40a, however, is positioned up-stream from working electrode upper element 39a so that when an adequate amount of the fluid sample (e.g., a whole blood sample) to completely cover the working electrode enters the capillary space, an electrical connection forms between counter electrode sub-element 40a and exposed portion of the working electrode 39a due to the conductivity of the fluid sample. The area of the counter electrode, however, that is available for contact by the fluid sample is so small that only a very weak current can pass between the electrodes and, thus, through the current detector. By programming the current detector to give an error signal when the received signal is below a certain pre-determined level, the sensor device may inform the user that insufficient blood has entered the sensor's cavity and that another test should be conducted. While the particular dimensions of the electrodes are not critical, the area of the counter electrode sub-element 40a is typically less than about 10% than that of the working electrode and, more specifically, less than about 6%. This element should be made as small as possible in view of the restraints of the screen printing process.

It is also contemplated that the reaction layer 44 may be removed from contact with counter electrode sub-element 40a. This is accomplished by producing a screen that does not print reagent ink over the counter electrode sub-element 40a. This serves the purpose of starving the sub-element for reagent, thereby not allowing it to function as a proper counter electrode, so that an error condition is achieved when the test fluid sample fails to contact the bulk of the counter electrode 40. While sub-element 40a is depicted as being physically connected to, and therefore part of, the counter electrode 40, such physical connection is not critical. Such sub-element may be physically disconnected from the rest of the counter electrode provided that it has its own connector and the sensor is equipped with a third contact to the detector.

The working and counter electrodes include electrode ink. The electrode ink, which is generally about 14 μm (0.00055″) thick, typically contains electrochemically active carbon. Components of the conductor ink may be a mixture of carbon and silver that is chosen to provide a low chemical resistance path between the electrodes and the meter with which they are in operative connection via contact with the conductive pattern at a fish-tail end 45 of the sensor. The counter electrode may be comprised of silver/silver chloride although carbon is preferred. To enhance the reproducibility of the meter reading, the dielectric pattern insulates the electrodes from the fluid test sample except in a defined area near the center of the electrode pattern 43. A defined area is important in this type of electrochemical determination because the measured current depends on the analyte concentration and the area of the reaction layer that is exposed to the analyte-containing test sample.

A typical dielectric layer 42 comprises a UV-cured acrylate modified polymethane that is about 10μ (0.0004″) thick. A lid or cover 46 is adapted to mate with the base to form a space to receive the fluid sample in which the counter and working electrodes are situated. The lid 46 provides a concave space 48, and is typically formed by embossing a flat sheet of deformable material. The lid 46 is punctured to provide an air vent 50 and joined to the insulating base 36 in a sealing operation. The lid 46 and base 36 can be sealed together by sonic welding in which the base 36 and lid 46 are first aligned and then pressed together between a vibratory heat sealing member or horn and a stationary jaw. The horn is shaped such that contact is made only with the flat, non-embossed regions of the lid. Ultrasonic energy from a crystal or other transducer is used to excite vibrations in the metal horn. This mechanical energy is dissipated as heat in the polymeric joint allowing the bonding of the thermoplastic materials. The embossed lid and base may be joined by using an adhesive material on the underside of the lid. The method of joining the lid and base are more fully described in U.S. Pat. No. 5,798,031 which is incorporated herein by reference in its entirety.

Suitable materials for the insulating base 36 include polycarbonate, polyethylene terephthalate, dimensionally-stable vinyl and acrylic polymers, and polymer blends such as polycarbonate/polyethylene terephthalate and metal foil structures (e.g., a nylon/aluminum/polyvinyl chloride laminate). The lid is typically fabricated from a deformable polymeric sheet material such as polycarbonate, or an embossable grade of polyethylene terephthalate, glycol modified polyethylene terephthalate or a metal foil composition (e.g., an aluminum foil structure). The dielectric layer may be fabricated from an acrylate-modified polyurethane that is curable by UV light or moisture or a vinyl polymer that is heat curable.

It is contemplated that other electrochemical sensors may be used in the present invention. Examples of electrochemical sensors that can be used to measure glucose concentrations are those used in Bayer Corporation's DEX®, DEX II®, ELITE®, and ASCENSIA® systems. More details on such electrochemical sensors may be found in U.S. Pat. Nos. 5,120,420 and 5,320,732 which are both incorporated by reference in their entirety. One or more of the electrochemical sensors may be purchased from Matsushita Electric Industrial Company. Another electrochemical sensor is disclosed in U.S. Pat. No. 5,798,031, which is incorporated by reference in its entirety. A further example of an electrochemical sensor that may be used in an amperometric monitoring system is disclosed in U.S. Pat. No. 5,429,735. It is contemplated that still other biosensors may be used in the present invention.

The electrochemical sensors may be located in a blood glucose sensor dispensing instrument that is adapted to have loaded therein a sensor pack that includes a plurality of sensors or testing elements. Each of the sensors is adapted to be ejected from the sensor pack. One example of a sensor pack loaded in a sensor dispensing instrument is disclosed in U.S. Pat. No. 5,660,791. It is contemplated that the electrochemical sensors may be stored in other apparatus such as bottles.

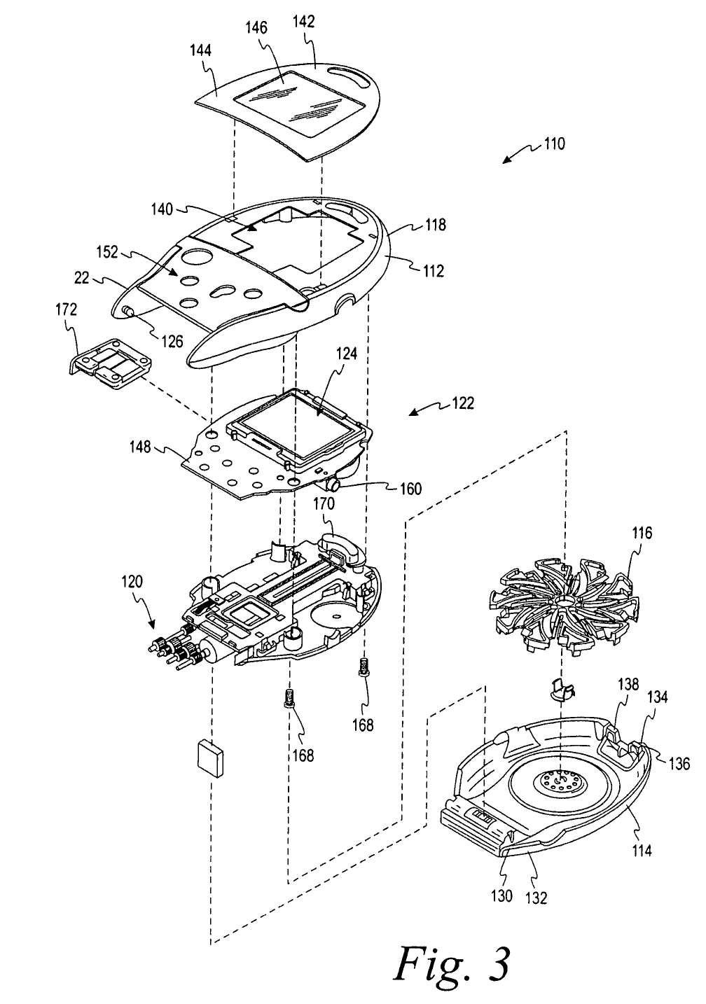

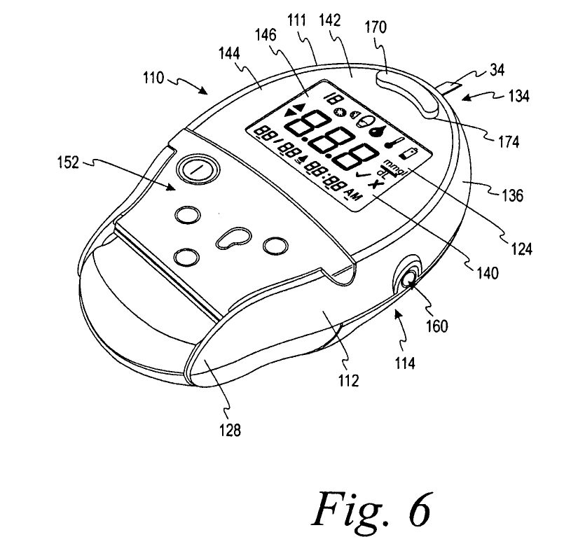

Referring now to FIGS. 3-6, therein is disclosed a testing device 110 adapted to dispense and utilize the above-described test sensor 34. The testing device 110 includes an outer housing 111 (FIG. 6) formed by an upper case 112 and a lower case 114, the lower case 114 pivoting on the upper case 112. The upper case 112 is pivotable with respect to the lower case 114 in a clamshell fashion so that a sensor pack (not shown) can be positioned on an indexing disc 116 within the housing 111. With the sensor pack so loaded in the housing 111, a test sensor can be dispensed from the sensor pack into a testing position on a front end 118 of the testing device 110. The testing device 110 includes a sensor disc drive mechanism 120 to load a test sensor into a testing position on the front end 118 of the housing 111.

After the test sensor 34 has been completely ejected from the sensor pack and pushed into a testing position projecting out from the front end 118 of the housing 111, the test sensor 34 is coupled to an electronics assembly 122 disposed in the upper case 112. The electronics assembly 122 includes a microprocessor or the like for processing and/or storing data generated during the blood glucose test procedure, and displaying the data on a liquid crystal display 124 in the testing device 110. Additionally, the electronics assembly 122 may also include a distinct memory device coupled to the microprocessor that has a non-volatile memory portion adapted to store data thereon.

The test sensor 34 is coupled to the electronics assembly 122 by a pair of metal contacts (not shown) that project into a sensor opening and engage the working electrode 39a and the counter electrode 40a on the test sensor 34. The metal contacts also apply a frictional force to the test sensor 34 so that the test sensor 34 does not prematurely fall out of the sensor opening prior to completion of the glucose testing procedure. According to one embodiment, the metal contacts are somewhat flexible and are made of stainless steel. The metal contacts permit the transmission of electrical signals between the test sensor 34 and the electronics assembly 122 during a test procedure.

The upper case 112 and the lower case 114 are complementary, generally oval shaped hollow containers that are adapted to be pivoted with respect to each other about pivot pins 126 extending outwardly in the rear end 128 of the upper case 112 into pivot holes 130 in a rear section 132 of the lower case 114. The upper case 112 and the lower case 114 are maintained in their closed configuration by a latch 134 that is pivotally mounted in a front section 136 of the lower case 114. The latch 134 has recesses 138 that are configured to mate with hooks (not shown) on the upper case 112 to secure the upper case 112 and the lower case 114 in their closed configuration. The latch 134 is biased in a vertical or closed position by a latch spring (not shown). When the latch 134 is pivoted against the biasing force of the latch spring, the hooks on the upper case 112 disengage from the recesses 138 to permit the upper case 112 and the lower case 114 to open.

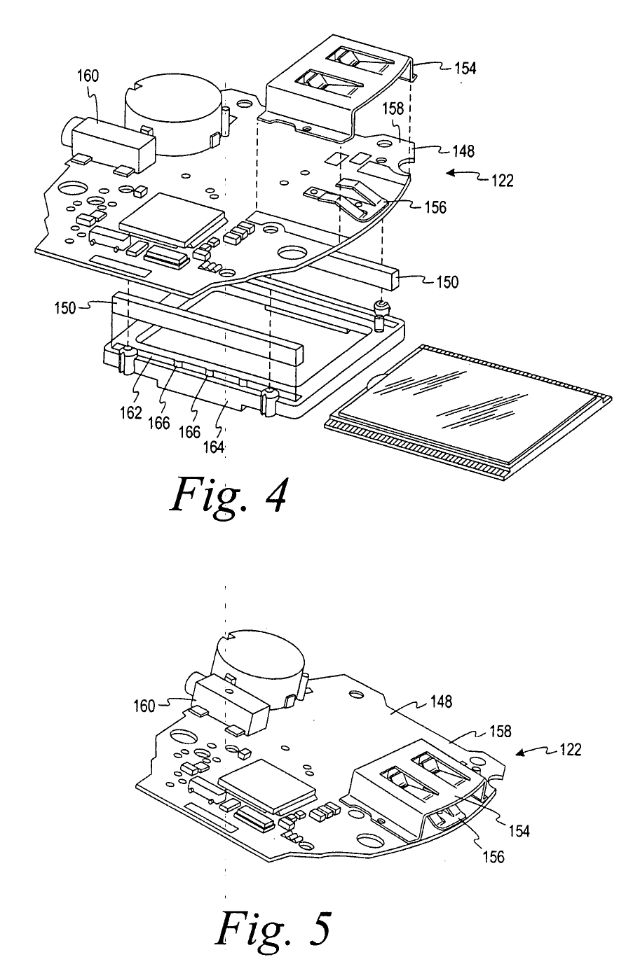

The upper case 112 includes a rectangular opening 140 through which the liquid crystal display 124 is visible below. The liquid crystal display 124 is visible through a display lens 142 that is affixed to upper surface of the upper case 112. In the preferred embodiment shown, the display lens 142 has an opaque portion 144 and a transparent portion 146, the transparent portion 146 being coincident with the display area of the liquid crystal display 124. The liquid crystal display 124 is a component of the electronics assembly 122, and is coupled to a circuit board assembly 148 via elastomeric connectors 150 (see FIG. 4). The liquid crystal display 124 displays information from the testing procedure and/or in response to signals input by a button set 152 on the upper case 112. For example, one of the buttons within the button set 152 can be depressed to recall and view the results of prior testing procedures on the liquid crystal display 124. The button set 152 is attached to the upper case 112 from below so that the individual buttons project upwardly through button openings (not shown) in the upper case 112. When pressed, the buttons are electrically connected to the circuit board assembly 148.

The upper case 112 also contains an opening (not shown) for a battery tray assembly 172. The battery tray assembly 172 includes a battery tray in which a battery is disposed. The battery tray assembly 172 is inserted into the opening in the upper case 112. When so inserted, the battery engages one or more battery contacts 154 and 156 (FIG. 4) on the circuit board assembly 148 so as to provide power for the electronics within the testing device 110, including the circuitry on the circuit board assembly 148 and the liquid crystal display 124. A tab on the lower case 114 is configured to engage a slot in the battery tray assembly 172 so as to prevent the battery tray assembly 172 from being removed from the testing device 110 when the upper case 112 and the lower case 114 are in the closed configuration.

An electronics assembly 122 is affixed to the upper inside surface of the upper case 112. As best seen in FIGS. 4-5, the electronics assembly 122 comprises a circuit board assembly 148 on which various electronics and electrical components are attached. A positive battery contact 154 and a negative battery contact 156 are disposed on the bottom surface 158 (which is the upwardly facing surface as viewed in FIGS. 4-5) of the circuit board assembly 148. The battery contacts 154 and 156 are configured to electrically connect with the battery when the battery tray assembly 172 is inserted into the upper case 112. The bottom surface 158 of the circuit board assembly 148 also includes a communication interface 160. The communication interface 160 permits the transfer of testing or calibration information between the testing device 110 and another device, such as a personal computer, through standard cable connectors (not shown). In the preferred embodiment shown, the communication interface 160 is a standard serial connector. However, the communication interface 160 could alternatively be an infra-red emitter/detector port, a telephone jack, or radio frequency transmitter/receiver port. Other electronics and electrical devices, such as memory chips for storing glucose test results or ROM chips for carrying out programs, are likewise included on the bottom surface 158 and an upper surface (not shown) of the circuit board assembly 148.

The liquid crystal display 124 is affixed to the upper surface of the circuit board assembly 148. The liquid crystal display 124 is held by a snap-in display frame. The snap-in display frame includes a plurality of snap fasteners that are configured to engage mating holes on the circuit board assembly 148. The liquid crystal display 124 is electrically connected to the electronics on the circuit board assembly 148 by a pair of elastomeric connectors 150 disposed in slots 162 in the snap-in display frame 164. The elastomeric connectors 150 generally comprise alternating layers of flexible conductive and insulating materials so as to create a somewhat flexible electrical connector. In the preferred embodiment shown, the slots 162 contain a plurality of slot bumps 166 that engage the sides of the elastomeric connectors 150 to prevent them from falling out of the slots 162 during assembly.

The button set 152 also mates to the upper surface of the circuit board assembly 148. As mentioned above, the button set 152 comprises several individual buttons that are depressed to operate the electronics of the testing device 110. For example, the buttons can be depressed to activate the testing procedure of the testing device 110. The buttons can also be depressed to recall and have displayed on the liquid crystal display 124 the results of prior testing procedures. The buttons can also be used to set and display date and time information, and to activate reminder alarms which remind the user to conduct a blood glucose test according to a predetermined schedule.

It should be noted that, as used within this application, the term “predetermined” means to establish in advance of a particular event, such as a sensing, measurement, etc. The term “predetermined” does not require that establishment in advance be permanent or constant, but simply that it be established in advance of the event. The predetermination may be modified, edited, changed, updated, reset, or replaced as desired by the operator, user, or manufacturer of the testing device 110 or the test sensor 34.

The sensor disc drive mechanism 120 is affixed to the upper inside surface of the upper case 112. As best seen in FIG. 3, the sensor disc drive mechanism 120 is attached to the upper case by a plurality of mounting screws 168 that engage posts (not shown) on the upper inside surface of the upper case 112. The mounting screws 168 also pass through and secure the electronics assembly 122, which is disposed between the sensor disc drive mechanism 120 and the upper case 112.

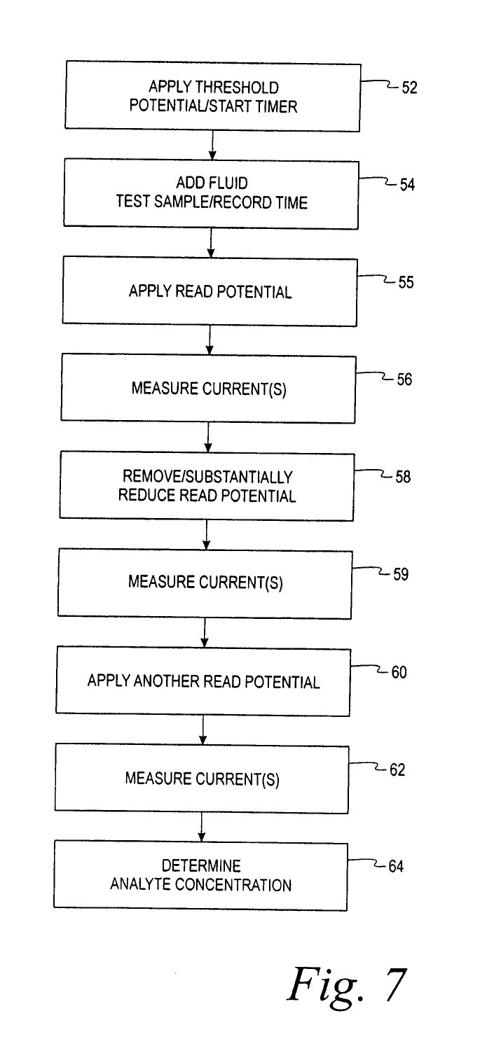

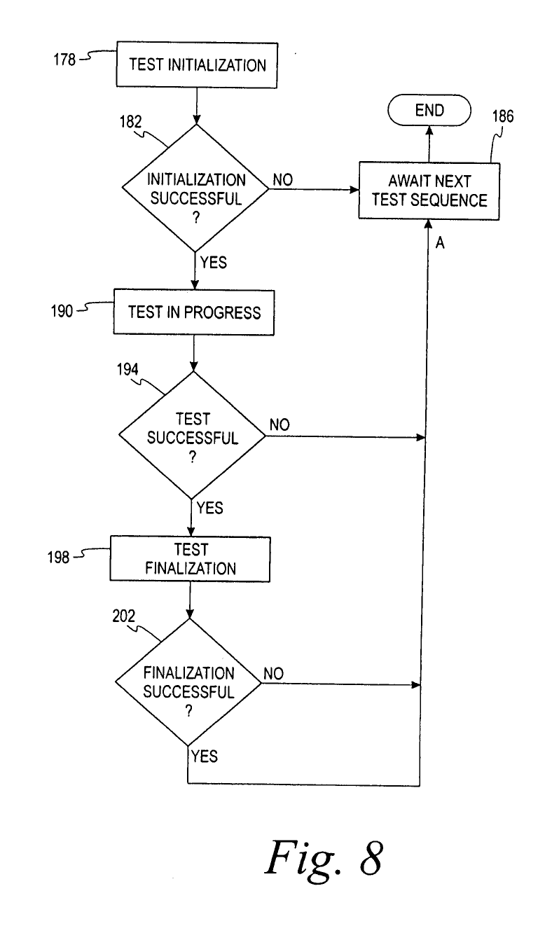

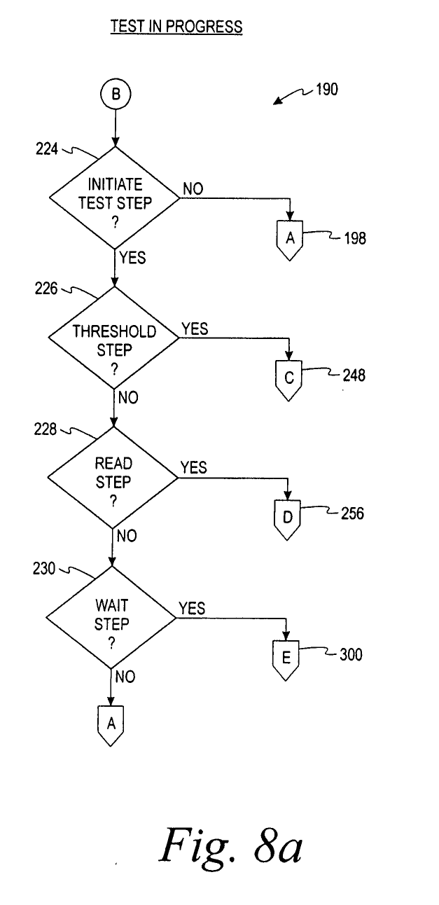

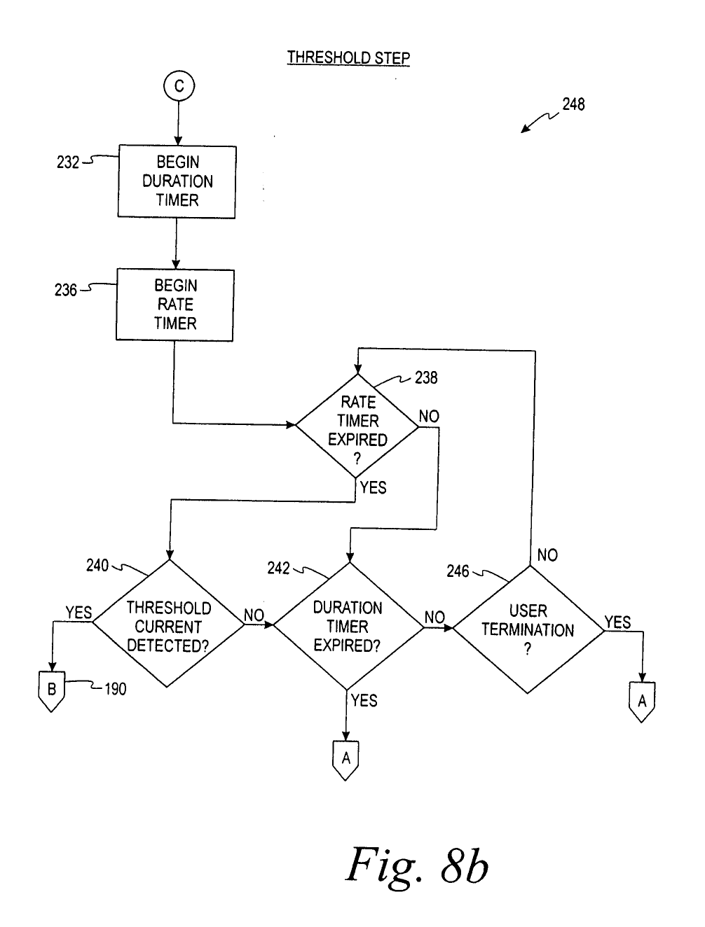

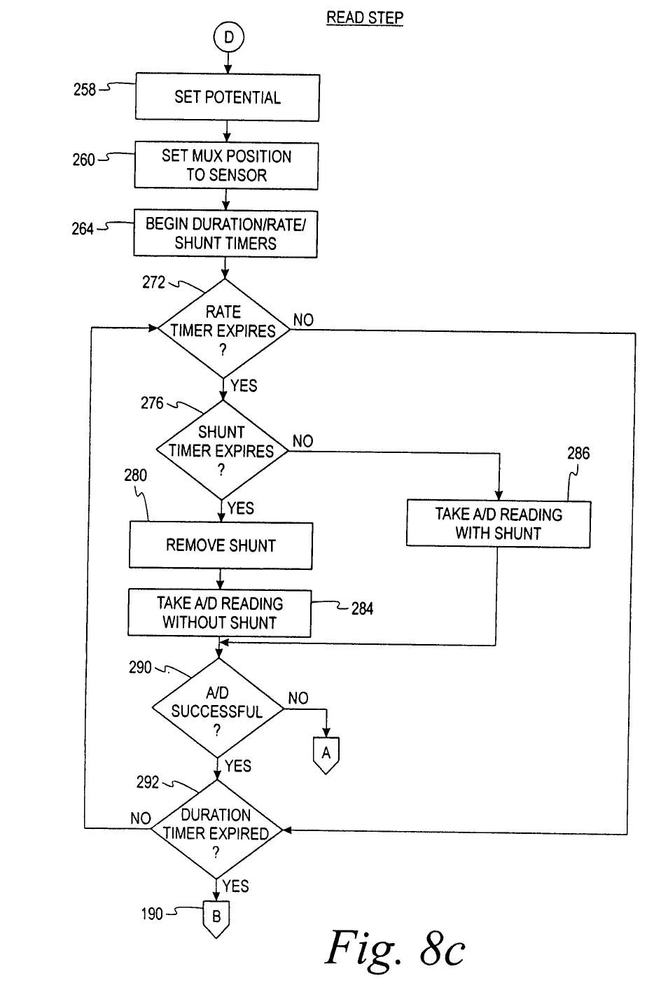

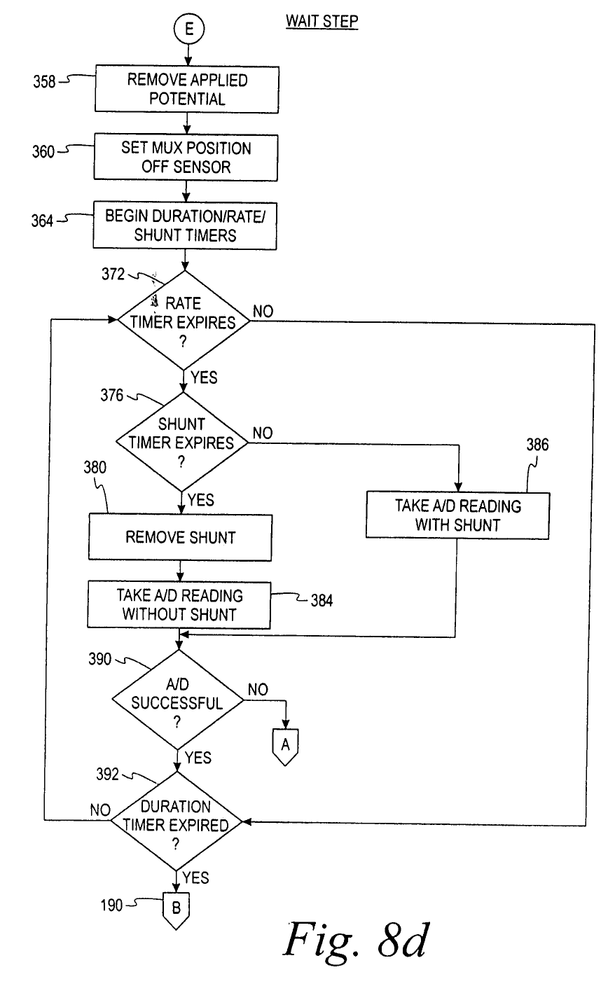

FIG. 6 illustrates the testing device 110 in its operational position with a test sensor 34 positioned in the latch 134. In this position, the test sensor 34 can be moved to a fluid-collection site (e.g., puncture site on a test subject) to allow the fluid sample (e.g., whole blood sample) to enter the capillary space of the test sensor 34. The fluid sample contacts the working electrode sub-element 39a and the counter electrode sub-element 40a. The testing device 110 then performs a test sequence as will be explained with respect to FIGS. 7-8f. When the test sequence has completed, a button release 170 is depressed to release the test sensor 34 from the testing position. The button release 170 extends through the opening 174 in the housing 111 and, when depressed, releases the test sensor 34 from the latch 134 to allow the test sensor 34 to be removed from the testing device 110.

Referring now to FIG. 7, a method for determining the concentration of an analyte in a fluid sample is illustrated. The method may include using one of the electrochemical sensors described above (e.g., test sensor 34), though it is contemplated that various electrochemical sensors and testing devices may be used other than those described in connection with FIGS. 1-3.

To begin the determination of the concentration of an analyte in a fluid sample a threshold potential between the counter electrode 40a and working electrode 39a is applied at step 52. The threshold potential is applied between the counter and working electrodes 40a, 39a for a first predetermined time period. Additionally, a sampling rate timer is initiated at step 52 that specifies how often the testing device 110 performs a determination as to whether a fluid test sample has been added. The fluid sample with analyte is then added so as to contact the electrochemical sensor 34 in step 54. A time/date stamp may be recorded when the fluid sample is first sensed by the testing device 110.

After the fluid sample has been added, a read potential is applied at step 55. The current is measured between the counter electrode 40a and working electrode 39a at a plurality of intervals, and the times of the measurements are recorded during the first predetermined time period during step 56. The current during the first predetermined time period may be measured. During the measuring of the current, the time and value of such measurements is recorded. The first predetermined time period may be referred to as the “burn” period.

During step 58, the read potential between the counter electrode 40a and working electrode 39a is removed or substantially reduced for a second predetermined time period. The second predetermined time period is referred to as the “wait” or “incubation” period. The current (produced by the chemistry on the test sensor 34) may be measured between the counter electrode 40a and working electrode 39a at a plurality of intervals, and the times and values of the measurements are recorded during the second predetermined time period during step 59.

Another read potential between the counter electrode 40a and working electrode 39a is applied for a third predetermined time period at step 60. The current is measured between the counter and working electrodes 40a, 39a during the third predetermined time period in step 62. The time and current values during the third predetermined time period may be measured. The third predetermined time period is referred to as “read” period. According to another method, the second and third predetermined time periods may be eliminated.

According to one method, the concentration of the analyte is determined in the fluid sample as a function of the current measured during any predetermined time period in step 64. It is contemplated, however, that the concentration of the analyte may be determined as a function of the current measured during the first predetermined time period.

The method for determining the analyte concentrations (e.g., glucose concentrations) may be performed in disposable self-testing systems. The disposable self-testing systems are often used by end consumers, especially those who are diabetic. Alternatively, the method for determining the analyte concentrations (e.g., glucose concentrations) may be performed in clinical analyzers. Clinical analyzers are often used in hospitals or clinics.

The testing end of the test sensor 34 is adapted to be placed into contact with the fluid sample (e.g., a whole blood sample) to be tested. Where the fluid sample to be used is a whole blood sample, the sample may be generated by a lancing device such as a MICROLET® lancing device. The lancing device may obtain blood by, for example, pricking a person's finger. According to one process, the whole blood sample may be prepared for testing by (a) removing the electrochemical sensor from a packet, (b) placing the electrochemical sensor into a glucose concentration measuring instrument, (c) generating a whole blood sample, and (d) bringing the sensor and the whole blood sample into contact wherein the blood is generally drawn into the sensor by capillary action.

According to one process, a whole blood sample is introduced into the capillary space via an introducing port. Gas is discharged from the capillary space by the inflow of the whole blood sample via a discharge port. It is believed that the glucose in the whole blood sample reacts with the enzyme (e.g., glucose oxidase carried on the electrodes to produce gluconic acid). A voltage is applied between the metal contacts of the testing device 110 and one or more of the electrodes on the test sensor 34. The voltage is generally polarized in the anode direction. By applying a voltage in the anode direction, an oxidizing current for the produced hydrogen peroxide is obtained. This current level corresponds to the concentration of glucose in the whole blood sample.

As will be further detailed below, one or more test-sequence tables are provided in the memory of the electronics assembly 122 of the testing device 110. The values required for each test step described below are provided within a plurality of individual blocks provided within a test-sequence table. A test-sequence table is accessible by a software program operable by the microprocessor of the testing device 110. Thus, by adjusting the order of the blocks within a test-sequence table—or the values provided within the plurality of blocks—the parameters of the test steps within a test sequence can be adjusted without altering the software program hard-coded within the testing device 110.

Turning now to FIG. 8, a method of performing a test sequence utilizing a testing device—such as the above-described testing device 110—is illustrated according to one embodiment of the present invention. The test sequence begins with a test initialization step at step 178. The test initialization step 178 may be initiated in a variety of ways. For example, in one embodiment, the test initialization step 178 is initiated by loading a test sensor 34 into an operational position in the testing device 110 as illustrated in FIG. 6. According to another embodiment, the test initialization step 178 is initiated when a user depresses one or more of the buttons included with the button set 152 of the testing device 110. In still other embodiments, the test initialization step 178 is initiated by the actuation of a push-pull mechanism within a testing device. It should be apparent, however, that the way in which the test initialization step 178 is initiated is not determinative of the operation of the test initialization step 178 and has been described for example only.

The hard-coded software is implemented using a state-machine model adapted to run on a microprocessor. During the test initialization step 178, the state-machine is initialized by taking one or more required Analog-to-Digital (A/D) measurements. If a determination is made at step 182 that the initialization was successful, the state machine advances to the test-in-progress state at step 190. Alternatively, if the initialization was not successful, the state machine performs a state-machine cleanup and awaits the next test sequence at step 186. Thus, the state machine awaits the initiation of a new test sequence, for example, when a new test sensor 34 is inserted into the testing device 110.

As will be further detailed with respect to FIG. 8a, the test-in-progress step 190 determines which of a plurality of test steps within a test sequence to process. For purposes of this application, a test sequence comprises a plurality of test steps that are executed on a single test sensor 34. An individual test step includes a plurality of parameters and can generally be divided into three types; (1) “threshold” (illustrated in FIG. 8b), (2) “read/burn” (hereinafter referred to as “read” and illustrated in FIG. 8c), and (3) “wait” (illustrated in FIG. 8d). However, it should be apparent that additional or alternative test steps can be utilized within the framework of the present invention and that not all three of the above-described test steps need to be included in a particular test sequence. The test sequence can be adjusted for the various test sensor, chemistry, testing device, or combinations thereof that are being used to perform a fluid sample analysis. The number of test steps and the order in which the test steps are processed is variable to accommodate the various combinations.

Typically, a single threshold detect step is included within a particular test sequence. Generally, the threshold detect step is processed first followed by one or more read and/or wait steps. Generally, at least one read step is included within the test sequence and often, a plurality of read steps are included, wherein two or more of the read steps may be separated by at least one wait step. The threshold detect step is used to detect when an appropriate amount of a fluid sample has been received by the test sensor 34 to perform an analysis thereof. The wait step is used to provide a period during which a current is no longer supplied by the testing device 110 to the test sensor 34. The read steps and wait steps are used to initiate and perform an A/D reading on the test sensor 34 containing the fluid sample.

After the test steps have begun being processed in the test-in-progress step 190, a determination is made at step 194 whether the test steps were successfully processed. If the test steps were not successfully processed, the state machine performs a state-machine cleanup and awaits the next test sequence at step 186. Alternatively, if the test steps were successfully processed, the state machine advances to a test-finalization state at step 198.

The test-finalization step 198 may perform any additional final A/D measurements. A determination is then made at step 202 as to whether the test-finalization step 198 was successfully completed. If all of the required A/D measurements were completed successfully, the state machine performs a state-machine cleanup and awaits the next test sequence at step 186. Similarly, if the test-finalization step 198 was not successfully completed, the state machine performs a state-machine cleanup and awaits the next test sequence at step 186.

Referring now to FIG. 8a, a test-in-progress step 190 is illustrated, according to one embodiment of the present invention. At step 224, a determination is made as to whether to initiate a test step within the test sequence. If there are no further test steps within the test sequence to process, the state machine proceeds to the test finalization step 198. Alternatively, if one or more test steps remain to be processed within the test sequence, the state machine determines (at steps 226, 228, and/or 230) which test step to process next. For example, at step 226 a determination is made as to whether a threshold step 248 is to be processed next. If the threshold step 248 is to be processed next, the various values for the threshold step 248 are accessed from the test-sequence table and are utilized to process the threshold step 248, as illustrated in FIG. 8b.

If the threshold step 248 is not to be processed next, a determination is made at step 228 as to whether a read step 256 is to be processed next. If the read step 256 is to be processed next, the various values for the read step 256 are accessed from the test-sequence table and are utilized to process the read step 256, as illustrated in FIG. 8c. If, however, the read step 256 is not to be processed next, a determination is made at step 230 as to whether a wait step 300 is to be processed next.

When the wait step 300 is to be processed next, the various values for the wait step 300 are accessed from the test-sequence table and are utilized to process the wait step 300, as illustrated in FIG. 8d. However, when a determination is made at step 224 that an additional test step has yet to be processed, but a determination is made at each of the test step decision boxes 226, 228, and 230 that the respective test step is not to be processed next, an error has occurred within the state machine. As such, the state machine performs a state-machine cleanup and awaits the next test sequence at step 186. Alternatively, test-in-progress step 190 can be modified so as to cycle through decision boxes 226, 228, and 230 for a predetermined period of time prior to performing a state machine cleanup.

The various steps and order of the test steps of the test sequence that are initiated at step 224 are determined by the state machine. To determine the order of the test steps the state machine accesses a test-sequence table located on a memory device within (or in communication with) the state machine. According to one embodiment of the present invention, the test-sequence table contains the number of each of the various test steps (e.g., threshold, read, wait) that are to be performed and in what order the test steps will be performed. The test-sequence table contains a plurality of blocks therein. Each of the plurality of blocks represents a particular test step to be processed by the state machine. The blocks within the test-sequence table further specifies the values that are to be used for each of the various test steps.

Referring now to FIG. 8b, the threshold step 248 is illustrated, according to one embodiment. The threshold step 248 begins by starting a duration timer at step 232. After the duration timer has been begun, a rate timer is begun at step 236. The duration timer counts down a predetermined time period during which a threshold current can be sensed by the testing device 110 at step 240. The rate timer counts down a time period after which the testing device 110 will sense to determine whether a threshold current is detected. The duration timer is typically a multiple of the rate timer.

After the rate timer has been started, a determination is made at step 238 as to whether the rate timer has expired. If the rate timer has not expired, the state machine determines whether the duration timer has expired at step 242. If the duration timer has expired, the state machine performs a state-machine cleanup and awaits the next test sequence at step 186. Alternatively, if the duration timer has not expired, a determination is made, at step 246, as to whether a user has terminated the process. If a determination is made at step 246 that the user has terminated the process, the state machine performs a state-machine cleanup and awaits the next test sequence at step 186. If, however, the user has not terminated the process, the state machine again determines, at step 238, whether the rate timer has expired.

If, alternatively, the rate time has expired, the testing device 110 senses whether a threshold current is detected at step 240. To perform this sensing, a voltage is applied to the test sensor 34 by the electronics assembly 122 (FIGS. 3-5) via the metal contacts. The current from the test sensor 34 is sensed by the electronics assembly 122 to determine whether a predetermined threshold current has been achieved. As the analyte within the fluid sample contacts the chemistry within the test sensor 34, a current is produced that is transmitted through the electrodes on the test sensor 34 and is detected by the testing device 110. The threshold current indicates that a sufficient fluid sample should have been obtained by the test sensor 34 such that an analysis to determine the concentration of the analyte in the fluid sample can be accurately performed. If, at step 240, a determination is made that the threshold current has not been detected, the state machine determines whether the duration timer has expired at step 242.

If the duration timer has expired, the state machine performs a state-machine cleanup and awaits the next test sequence at step 186. Alternatively, if the duration timer has not expired, the determination is made, at step 246, as to whether the user has terminated the process. If the determination is made at step 246 that the user has terminated the process, the state machine performs a state-machine cleanup and awaits the next test sequence at step 186. If, however, the user has not terminated the process, the state machine again determines, at step 238, whether the rate timer has expired and the process continues until the duration time expires at step 242, the user terminates the process at step 246, or a threshold fluid sample is received at step 240. If a determination is made at step 240 that a threshold current has been sensed, then the testing device 110 assumes that a sufficient fluid sample has been obtained to perform the desired analysis, the state machine again determines whether to initiate another test step at step 224 (FIG. 8a).

Detection of a threshold fluid sample is generally referred to as a threshold step 248. The values required for the state machine to conduct the threshold step 248 are illustrated in a table that is accessible by the state machine. The table is comprised of a plurality of blocks, each block comprising a plurality of attributes. Sample values are described in greater detail with respect to Example 1 below. For example, a table for the threshold step 248 may be adapted to specify the length of the duration timer, the voltage to be applied by the electronics assembly 122, the sampling rate (e.g., the time between interrogations of the test sensor 34 to determine the current), and the threshold trip current, which is the current level that the test sensor 34 must minimally produce to determine that a sufficient amount of the fluid sample may have been received.

In the illustrated embodiment, the test sequence began with a threshold step 248. Once the threshold step 248 is successfully completed the next test step of the test sequence is determined within the test-in-progress step 190. Typically the next test step is a read step 256 or a wait step 300 though, in some embodiments, the next step may be a second threshold step.

Referring now to FIG. 8c, if the next step is a read step 256 (such that the test sequence through this point comprises a threshold step 248 followed by a read step 256), a shunt may be applied to the circuit along with a potential. At step 258, a potential to apply to the circuit is set based on the value obtained from the read-step block within the test-sequence table as will be further detailed below. The MUX position is set to the test sensor 34 at step 260. A plurality of timers are then begun at step 264. The first timer that is begun at step 264 is a duration timer that determines the overall amount of time that the read step 256 can be performed in. The second timer begun at step 264 is a rate timer that determines the amount of time between readings during the read step 256. The third timer begun at step 264 is a shunt timer that determines the overall amount of time that the shunt should be applied, if at all. The shunt timer may be equal to or less than the duration timer.

Once the plurality of timers have been begun, the state machine awaits the expiration of the rate timer. A determination is made at step 272 as to whether the rate timer has expired. If the rate timer has not expired, the state machine determines, at step 292, whether the duration timer has expired. If the duration timer has not expired, another determination is made at step 272 as to whether the rate timer has expired. This process continues until either the rate timer of the duration timer expires. Once a determination is made that the duration timer has expired, the read step 256 has completed and the next test step of the test sequence is determined within the test-in-progress step 190. In some embodiment, where the use of a shunt is desirable, a determination may be made that the rate timer has expired, a determination is made at step 276 as to whether the shunt duration time has expired. If the shunt timer has not expired, an A/D reading may be taken at step 286 with the shunt. Alternatively, if the shunt timer has expired, the shunt is removed at step 280 and an A/D reading is taken at step 284 within the shunt.

A shunt is a resistor selectively switched into the circuit to reduce the gain of a transimpedence amplifier contained within the electronics assembly 122. The shunt generally reduces the resistance of the electrical circuit and as such lowers the gain of the system. This, in turn, allows the system to handle a higher current.

After an A/D reading has been performed at step 284 or step 286, a determination is made, at step 290, as to whether the A/D reading was successful. If the A/D reading is unsuccessful, the state machine performs a state-machine cleanup and awaits the next test sequence at step 186. If, however, the A/D reading is successful, a determination is made at step 292 as to whether the duration timer has expired. If the duration timer has not expired, the state machine again determines at step 268 whether the rate time has expired and the read step 256 continues. Once the duration timer has expired, the read step 256 has completed and the next test step of the test sequence is determined within the test-in-progress step 190. The state machine continues to process the remaining test steps in the test sequence until all of the test steps have been completed or until an error occurs.

Typically, the next test step is a read step 256 or a wait step 300 though, in some embodiments, the next step may be a second threshold step 248. For example, referring also to FIG. 8d, a wait step 300 is illustrated according to one embodiment of the present invention. The wait step 300 is similar to the above-discussed read step 256 except that, generally, a potential is not applied to the test sensor 34 during the wait step 300. In the illustrated embodiment, however, a potential may be generated by the chemistry on the test sensor 34 and one or more A/D readings may be performed to determine this potential. Examples of such techniques can be found in U.S. Pat. No. 6,251,260 and PCT Publication No. WO2005/022143, both of which are incorporated herein in their entirety.

According to one embodiment, any potential from the testing device 110 being applied to the test sensor 34 is removed. The MUX position is set so as to be off the test sensor 34 at step 360. A plurality of timers are then begun at step 364. The first timer that is begun at step 364 is a duration timer that determines the overall amount of time that the wait step 300 can be performed in. The second timer begun at step 364 is a rate timer that determines the amount of time between readings, if any, during the wait step 300. The third timer begun at step 364 is a shunt timer that determines the overall amount of time that the shunt should be applied, if at all. The shunt timer may be equal to or less than the duration timer.

Once the plurality of timers have been begun, the state machine awaits the expiration of the rate timer. A determination is made at step 372 as to whether the rate timer has expired. If the rate timer has not expired, the state machine determines, at step 392, whether the duration timer has expired. If the duration timer has not expired, another determination is made at step 372 as to whether the rate timer has expired. This process continues until either the rate timer or the duration timer expires. Once a determination is made that the duration timer has expired, the wait step 300 has completed and the next test step of the test sequence is determined within the test-in-progress step 190. Alternatively, if a determination is made that the rate timer has expired, a determination is made at step 376 as to whether the shunt duration time has expired. If the shunt timer has not expired, an A/D reading is taken at step 386 with the shunt. Alternatively, if the shunt timer has expired, the shunt is removed at step 380 and an A/D reading is taken at step 384 within the shunt.

A shunt is a resistor selectively switched into the circuit to reduce the gain of a transimpedence amplifier contained within the electronics assembly 122. The shunt generally reduces the resistance of the electrical circuit and as such lowers the gain of the system. This, in turn, allows the system to handle a higher current.

After an A/D reading has been performed at step 384 or step 386, a determination is made, at step 390, as to whether the A/D reading was successful. If the A/D reading is unsuccessful, the state machine performs a state-machine cleanup and awaits the next test sequence at step 186. If, however, the A/D reading is successful, a determination is made at step 392 as to whether the duration timer has expired. If the duration timer has not expired, the state machine again determines at step 368 whether the rate time has expired and the wait step 300 continues. Once the duration timer has expired, the wait step 300 has completed and the next test step of the test sequence is determined within the test-in-progress step 190. The state machine continues to process the remaining test steps in the test sequence until all of the test steps have been completed or until an error occurs.

Turning back to FIG. 8a, once it has been determined, at step 224, that no further test steps are to be initiated because the test sequence is complete, the state machine proceeds to a test finalization step 198. The test finalization step 198 performs any required final A/D measurements, performs state machine cleanup, and advances to the test initialization sub-state to await a subsequent test.

It should be noted that the glucose (or other analyte) concentrations in the fluid sample can be calculated from the above A/D measurements and may be stored in a memory device located within (or in communication with) the testing device 110. The stored analyte concentrations could be accessed by the microprocessor within the testing device 110 to display the values to a user on the LCD 124 (FIG. 3) or to further process and interpret the values as desired by the operator of the testing device 110. These values may be stored for a predetermined period of time, indefinitely, until removed by a user, and/or the values may be programmed to be deleted when additional memory space is required.

Further, a user may be allowed to terminate the test procedure at any time during the process. Anytime a user terminates the test procedure the state machine performs a state-machine cleanup and awaits the next test sequence at step 186.

Although the above description has described a test sequence table with respect to the controlling of a test sequence based on the plurality of attributes defined within the test-sequence table, it should be noted that the tables of the present invention may be utilized to control, monitor, and establish other procedures as well. For example, according to one embodiment, the test-sequence table is utilized to establish the sampling times and/or sequence of the chemistry on a test sensor (e.g., test sensor 34) once an analyte sample has been applied thereto. In this embodiment, the test-sequence table contains a plurality of sampling times for each block within the test-sequence table. The blocks may include, for example, a standard block and a non-standard block.

The following is a hypothetical example of a test-sequence table that is provided with illustrative attributes and values for the blocks that may define the types of test steps that could be included within a test sequence. It should be noted that various blocks and attributes can be utilized with the present invention and are not limited to the illustrated attributes and blocks described below. Predetermined values for the selected attributes for each test step are provided within the individual blocks of a test-sequence table. The test-sequence table is accessible by the software program operable by the microprocessor of the testing device 110. Thus, by adjusting the order of the blocks within the test-sequence table—or the values provided within the one or more blocks—the test steps within the test sequence can be adjusted without altering the software program hard-coded within the testing device 110.

### Example 1

| | |
|---|---|
| Test Step 0 | |
| Step Type: | Threshold |
| Time Resolution: | 0.25 sec |
| Duration: | 96,000 ticks |
| Potential: | 1 V |
| Rate: | 1000 ticks |
| Threshold Trip Current: | 1 mA |
| MUX Input Position: | sensor |
| Shunt Duration: | N/A |
| Test Step 1 | |
| Step Type: | Read |
| Time Resolution: | 0.25 sec |
| Duration: | 1000 ticks |
| Potential: | 1 V |
| Rate: | 100 ticks |
| Threshold Trip Current: | N/A |
| MUX Input Position: | sensor |
| Shunt Duration: | 0 ticks |
| Test Step 2 | |
| Step Type: | Wait |
| Time Resolution: | 0.25 sec |
| Duration: | 1000 ticks |
| Potential: | 0 V |
| Rate: | 100 ticks |
| Threshold Trip Current: | N/A |
| MUX Input Position: | sensor |
| Shunt Duration: | 0 ticks |
| Test Step 3 | |
| Step Type: | Read |
| Time Resolution: | 0.25 sec |
| Duration: | 1000 ticks |
| Potential: | 1 V |
| Rate: | 100 ticks |
| Threshold Trip Current: | N/A |
| MUX Input Position: | sensor |
| Shunt Duration: | 400 ticks |

The above, hypothetical test sequence represented by Example 1 illustrates a four-step test sequence. The test sequence begins with a threshold step represented by the block labeled Test Step 0. The threshold step is followed by a first read step represented by the block labeled Test Step 1. A wait step, represented by the block labeled Test Step 2, follows the first read step. A second read step follows the wait step and is represented by the block labeled Test Step 3. Each of the various blocks includes a duration value defined by a number of ticks. A tick is defined herein as the smallest unit of time upon which all timing for the test sequence is based. A time-resolution value is provided that defines the length in real time for a single tick of the test sequence. Thus, for example, the real-time length of Test Step 0 is defined by the test-sequence table as 400 minutes (96,000 ticks*0.25 sec/tick=24,000 sec).

The test-sequence table further specifies the potential (e.g., voltage) that will be applied by the electronic circuitry 122 to the test sensor 34 during the particular test step. The rate defines how often an A/D reading will be initiated on the test sensor 34. In the case of a threshold step (e.g., Test Step 0) the rate defines how often the current level of the test sensor 34 will be interrogated to determine whether it is greater than or equal to the threshold trip current that is defined by the block labeled Test Step 0. The test-sequence table also defines the number of ticks (i.e., length of time) that a shunt is to be applied during an individual test step. For example, in the second read step (i.e., Test Step 3) the shunt is to be applied for 400 ticks of the total 1000 ticks for the test step.

The test-sequence table further defines the MUX positioning of the testing device 110 with respect to the test sensor 34. For example, the MUX (also known as a multiplexer) can electrically connect or disconnect the potential to/from the test sensor 34. The selected test-sequence table determines which, if any, device (e.g., reference resistor, thermistor, test sensor, etc.) is connected to the source potential. The MUX sends multiple signals on a carrier channel at the same time in the form of a single, complex signal to the test sensor 34.

It should be apparent from the above discussion that the test-sequence table above allows the test sequence—and the individual test steps defined therein—to be easily modified by adjusting the order of, or values defined within, the individual blocks within the test-sequence table. The test-sequence table can be stored on any suitable memory device in communication with the microprocessor within the testing device 110. In this manner, the adjustment of the test sequence can be performed without requiring the modification of the hard-coded software program operable by the microprocessor of the testing device 110.

For example, the blocks within the test-sequence table can be modified by linking an external device to the communication interface 160 (FIGS. 3-5) of the testing device 110. A new test-sequence table can then be stored on the memory device of the testing device 110 and the original test-sequence table can be deleted or, in alternative embodiments, remain on the memory device. Alternatively, a plug-in device can be placed in communication with the microprocessor and the software program can operate a test-sequence table stored on the plug-in device. In still other embodiments, the testing device 110 is equipped with a wireless communication device adapted to access or download a test-sequence table located on another device in another memory. It should be apparent to those skilled in the art that the test-sequence table can be modified, added, or replaced in any suitable means and the above listed methods are meant to serve as example only.

### Alternative Embodiment A

A method for controlling a test sequence for performing an analysis of an analyte in a fluid sample, the method comprising the acts of:

providing a hard-coded software application adapted to process a plurality of blocks to perform the test sequence, the plurality of blocks including a wait block, a read block, and a threshold block; and

providing a test-sequence table having a plurality of attributes defined therein for each of the plurality of blocks, the plurality of attributes being utilized by the software application to process the plurality of blocks,

wherein the test sequence is determined through the plurality of attributes defined within the test-sequence table.

### Alternative Embodiment B

The method of Alternative Embodiment A further comprising the act of modifying the test-sequence table without recoding the hard-coded software application.

### Alternative Embodiment C

The method of Alternative Embodiment B, wherein the test-sequence table is modified by changing the existing test-sequence table.

### Alternative Embodiment D

The method of Alternative Embodiment B, wherein the test-sequence table is modified by providing an additional test-sequence table accessible by the hard-coded software application.

### Alternative Embodiment E

The method of Alternative Embodiment A, wherein the plurality of blocks is processed in a predetermined order.

### Alternative Embodiment F

The method of Alternative Embodiment E, wherein the threshold block is processed prior to the read block or the wait block.

### Alternative Embodiment G

The method of Alternative Embodiment A, wherein the analyte is glucose and the plurality of attributes defined within the test-sequence table is for a blood-glucose analysis.

### Alternative Embodiment H

The method of Alternative Embodiment A, wherein the analyte is cholesterol and the plurality of attributes defined within the test-sequence table is for a blood-cholesterol analysis.

### Alternative Embodiment I

The method of Alternative Embodiment A, wherein the analyte is hydrogen ions and the plurality of attributes defined within the test-sequence table are for a pH analysis.

### Alternative Embodiment J

A computer readable storage medium encoded with instructions for directing a testing device to perform the method of Alternative Embodiment A.

### Alternative Embodiment K

A testing device adapted to utilize a test sensor in performing an analysis of an analyte in a fluid sample, the testing device comprising:

an electronics assembly adapted to provide a voltage to the test sensor and to determine an amount of current being transmitted by the test sensor;

a memory device capable of storing a test-sequence table thereon, the test-sequence table having a plurality of attributes defined therein; and

a processor in communication with the electronics assembly and the memory device, the processor being operable to
(i) perform a plurality of instructions contained within a software application,
(ii) access the plurality of attributes defined within the test-sequence table to perform a test sequence,
(iii) instruct the electronics assembly to provide the voltage to the test sensor, the voltage being defined by one of the plurality of attributes defined in the test-sequence table, and
(iv) instruct the electronics assembly to determine the amount of current being transmitted by the test sensor, the frequency of the determinations being based on one of the plurality of attributes.

### Alternative Embodiment L

The testing device of Alternative Embodiment K, wherein the memory device is located external to the testing device.

### Alternative Embodiment M

The testing device of Alternative Embodiment L, wherein the memory device is a plug-in device.

### Alternative Embodiment N

The testing device of Alternative Embodiment K, wherein the electronics assembly includes a communications interface in communication with the processor.

### Alternative Embodiment O

The testing device of Alternative Embodiment N, wherein the test-sequence table is modified via the communications interface.

### Alternative Embodiment P

The testing device of Alternative Embodiment K, wherein the software application is hard-coded on a memory device within the testing device.

### Alternative Embodiment Q

The testing device of Alternative Embodiment P, wherein the software application and the test-sequence table are located on the same device.

### Alternative Embodiment R

The testing device of Alternative Embodiment P, wherein the test sequence is adjusted by modifying the test-sequence table without modifying the software application.

### Alternative Embodiment S

A method for conducting a test sequence comprising the acts of:

providing a hard-coded software application adapted to process a plurality of blocks to perform the test sequence;

reading, for each of the plurality of blocks, a plurality of attributes defined within a test-sequence table, the plurality of attributes being utilized by the software application to process the plurality of blocks; and

controlling the test sequence based on the plurality of attributes defined within the test-sequence table.

### Alternative Embodiment T

A method for conducting a test sequence comprising the acts of:

providing a hard-coded software application adapted to process a plurality of blocks to perform the test sequence;

reading, for each of the plurality of blocks, a plurality of attributes defined within a test-sequence table, the plurality of attributes being utilized by the software application to process the plurality of blocks; and

sampling a test sensor at a plurality of times based on the plurality of attributes defined within the test-sequence table.

While the invention is susceptible to various modifications and alternative forms, specific embodiments and methods thereof have been shown by way of example in the drawings and are described in detail herein. It should be understood, however, that it is not intended to limit the invention to the particular forms or methods disclosed, but, to the contrary, the intention is to cover all modifications, equivalents and alternatives falling within the spirit and scope of the invention as defined by the appended claims.

What is claimed is:

1. A method for controlling a test sequence for performing an analysis of an analyte in a fluid sample, the method comprising the acts of:
providing a hard-coded software application adapted to process a plurality of blocks to perform the test sequence, the plurality of blocks including a wait block, a read block, and a threshold block; and
providing a test-sequence table having a plurality of attributes defined therein for each of the plurality of blocks, the plurality of attributes being utilized by the software application to process the plurality of blocks,
wherein the test sequence is determined through the plurality of attributes defined within the test-sequence table.

2. The method of claim 1 further comprising the act of modifying the test-sequence table without recoding the hard-coded software application.

3. The method of claim 2, wherein the test-sequence table is modified by changing the existing test-sequence table.

4. The method of claim 2, wherein the test-sequence table is modified by providing an additional test-sequence table accessible by the hard-coded software application.

5. The method of claim 1, wherein the plurality of blocks is processed in a predetermined order.

6. The method of claim 5, wherein the threshold block is processed prior to the read block or the wait block.

7. The method of claim 1, wherein the analyte is glucose and the plurality of attributes defined within the test-sequence table is for a blood-glucose analysis.

8. The method of claim 1, wherein the analyte is cholesterol and the plurality of attributes defined within the test-sequence table is for a blood-cholesterol analysis.

9. The method of claim 1, wherein the analyte is hydrogen ions and the plurality of attributes defined within the test-sequence table are for a pH analysis.

10. A computer readable storage medium encoded with instructions for directing a testing device to perform the method of claim 1.

11. A testing device adapted to utilize a test sensor in performing an analysis of an analyte in a fluid sample, the testing device comprising:
an electronics assembly adapted to provide a voltage to the test sensor and to determine an amount of current being transmitted by the test sensor;
a memory device capable of storing a test-sequence table thereon, the test-sequence table having a plurality of attributes defined therein; and
a processor in communication with the electronics assembly and the memory device, the processor being operable to
(i) perform a plurality of instructions contained within a software application,
(ii) access the plurality of attributes defined within the test-sequence table to perform a test sequence,
(iii) instruct the electronics assembly to provide the voltage to the test sensor, the voltage being defined by one of the plurality of attributes defined in the test-sequence table, and
(iv) instruct the electronics assembly to determine the amount of current being transmitted by the test sensor, the frequency of the determinations being based on one of the plurality of attributes.

12. The testing device of claim 11, wherein the memory device is located external to the testing device.

13. The testing device of claim 12, wherein the memory device is a plug-in device.

14. The testing device of claim 11, wherein the electronics assembly includes a communications interface in communication with the processor.

15. The testing device of claim 14, wherein the test-sequence table is modified via the communications interface.

16. The testing device of claim 11, wherein the software application is hard-coded on a memory device within the testing device.

17. The testing device of claim 16, wherein the software application and the test-sequence table are located on the same device.

18. The testing device of claim 16, wherein the test sequence is adjusted by modifying the test-sequence table without modifying the software application.

19. A method for conducting a test sequence comprising the acts of:
providing a hard-coded software application adapted to process a plurality of blocks to perform the test sequence;
reading, for each of the plurality of blocks, a plurality of attributes defined within a test-sequence table, the plurality of attributes being utilized by the software application to process the plurality of blocks; and
controlling the test sequence based on the plurality of attributes defined within the test-sequence table.

20. A method for conducting a test sequence comprising the acts of:
providing a hard-coded software application adapted to process a plurality of blocks to perform the test sequence;
reading, for each of the plurality of blocks, a plurality of attributes defined within a test-sequence table, the plurality of attributes being utilized by the software application to process the plurality of blocks; and
sampling a test sensor at a plurality of times based on the plurality of attributes defined within the test-sequence table.
